(19) United States
(12) Patent Application Publication
(10) Pub. No.: US 2005/0055400 A1
(43) Pub. Date: Mar. 10, 2005

(54) Method of inserting thematic filtering information pertaining to HTML pages and corresponding system

(76) Inventors: Eric Goutard, Douvres La Delivrande (FR); Olivier Daridan, Cheux (FR); Nicolas Saillard, Caen (FR)

Correspondence Address: FISH & RICHARDSON PC, 225 FRANKLIN ST, BOSTON, MA, 02110, US

(21) Appl. No.: 10/935,544

(22) Filed: Sep. 7, 2004

(30) Foreign Application Priority Data
Sep. 9, 2003 (FR) 0310618

(51) Int. Cl. G06F 7/00

(52) U.S. Cl. 709/203

(57) ABSTRACT

The invention relates to a method and a system for inserting thematic filtering information pertaining to objects accessible on an INTERNET site hosted by a server (SEⱼ) by a client facility (PCᵢ)

The access request (Req) is intercepted (A) so as to store at least one transaction parameter pertaining to this request, this request is transferred (B) to the server (SEⱼ) and upon response (Rep) containing at least one object of this site, the response (Rep) is intercepted (C) and at least one information-carrying computer object is selected from at least one object, a thematic analysis is performed (D) so as to produce a set of parameters (PT) characteristic of the site, coded categorization information IC (PT) is inserted (E) into the header of the response from the WEB server and/or the object itself, the response containing the categorization information is transferred (F) to the client facility (PCᵢ). This makes it possible to effect a control of access to the information of the objects at the level of the client facility (PCI). Application to the broadcasting of objects such as HTML pages over the INTERNET.

At the present time, routine access to the INTERNET network makes it possible to exchange a very great deal, of information of any kind, by access to the HTML pages or objects delivered from any INTERNET site. For the WEB surfer, some of this information may exhibit a violent, pornographic, paedophile, illegal, tendentious or subversive nature or simply be of no interest.

Consequently, techniques for filtering the content of accessible objects are presently available in the market, with the aim, in particular, of protecting under-age web surfers against access to such contents.

Among the aforementioned filtering techniques, mention may be made of those implemented by:
software installed on the client facility based on URL lists regularly updated by downloading;
software installed on the client facility based on thematic analysis engines;
software installed on the client facility based on categorization information included by the content providers in the HTML pages accessed, information such as the tags or “labels” published in accordance with the PICS standard, in particular;
network core filtering solutions based on equipment of “proxy” type and on regularly updated URL lists;
network core filtering solutions based on equipment of “proxy” type and on thematic analysis engines.
   Recall That the Initials
HTML: (HyperText Mark-up Language) designates a markup language used to specify the formatting of the documents in the World Wide Web;
URL: (Uniform Resource Locator) is the syntax used in the World Wide Web to specify the physical location of a file or of a resource on the INTERNET;
PICS: (Platform for INTERNET Content Selection) designates a standard for publishing tags.

Recall that the concept of network core covers any item of equipment of the network other than the client facility and the server hosting the INTERNET site accessed and that the concept of equipment of “proxy” type covers that of any software or hardware, possibly equipped with suchlike security software serving as intermediary between the browser of a client facility in a local area network and the WEB server hosting the INTERNET site that the user of this client facility wishes to consult.

The first category of solutions, executing a filtering on the client facility, is characterized essentially by the installation of elements on the client facility and the configuration of the latter.

The second category of solutions is characterized, on the contrary, by the absence of installation of elements on the client facility and by a minimum configuration so as to use the network core filtering solution.

Both the aforementioned categories of solutions do not offer total satisfaction, for the following reasons:
the solutions of the first category result in an overload of administration and of utilization, installation and regular updating of filters or of content analysis engine and network access cost to perform the downloading of the filters or content analysis engines. Among the solutions of the first aforementioned category, those which make use of the categorization according to the PICS standard, which saves the installation of software on the client facility by virtue of the interpretation by the browser of the tags or “labels” included in the objects accessed, are presently of limited interest, on account of the restricted number of INTERNET sites making use of such categorization.
The solutions of the second category are solutions shared among several web surfers and do not, for this reason, allow detailed customization of the types or of the kind of filtering that are applied.

An object of the present invention is to remedy the drawbacks of the prior art solutions, through the implementation of a method of and of a system for inserting thematic filtering information pertaining to objects accessible on an INTERNET site allowing, in particular, extremely detailed use and usage, it being possible for the final-filtering criteria to be left to the sole initiative of the web surfer of each client facility, or of the person having authority over this facility.

Another object of the present invention is the implementation of a method of and of a system for inserting thematic filtering information pertaining to objects accessible on an INTERNET site which, although exhibiting the aforesaid extremely detailed use and usage, require only the most minor of installations at the level of each client facility.

The concept of accessible object can cover entire pages in the HTML, XML or other formats, and also the objects contained in these pages: pictures, sound, videos, etc.

The method of inserting thematic filtering information pertaining to objects accessible on an INTERNET site hosted by a WEB server with the help of a browser of a client facility connected to the IP network, which is the subject of the present invention, is implemented for every request for HTTP access to this WEB server sent from the client facility by way of this browser.

It is noteworthy in that it consists, at the level of the network core, in intercepting the access request so as to store at least one transaction parameter of this request for HTTP access to this WEB server, transferring this request for access to the WEB server, and on response from this WEB server to this access request comprising at least one object accessible on this site, intercepting this response from this WEB server to this access request, selecting at least one object accessible on this site, performing a thematic analysis of this at least one object, so as to produce a set of thematic analysis parameters which is characteristic of this INTERNET site, inserting with the help of these thematic analysis parameters at least one coded categorization information item into the HTTP header of the response of the WEB server and/or into the object itself, transferring the response of the WEB server to the request for HTTP access to this WEB server with a header and/or a document body containing the categorization information to the client facility.

This then makes it possible, at the client facility, to effect a control of access to the information contained in the object or objects accessible on this site. The system for inserting thematic filtering information pertaining to objects accessible on an INTERNET site hosted by a WEB server with the help of a browser of a client facility connected to the IP network, which is the subject of the present invention, is noteworthy in that it comprises at least, at the level of the core of this network a module for interception, control and redirection of every HTTP request for access to this WEB server sent with the help of this client facility by way of this browser and of the response of this WEB server to this request, this module for interception, control and redirection making it possible at least to select from the response of this. WEB server at least one object accessible on this INTERNET site, a thematic analysis module interconnected with the said module interception, for control and redirection receiving this object so as to enhance it by means of thematic analysis parameters characteristic of this INTERNET site or of this object. The module for interception, control and redirection allows the transmission of the response of this WEB server enhanced by categorization information arising from the thematic analysis parameters to the client facility, in order to effect, at the level of the latter, a control of access to the information contained in this object accessible on this site.

The method of and the system for inserting thematic filtering information pertaining to objects accessible on an INTERNET site, which are the subject of the invention, find application to the control of access to sensitive, undesirable or useless information and, more generally, to the regulating of the flow of this type of information by the empowered authorities.

They will be better understood on reading the description and on looking at the drawings below in which:

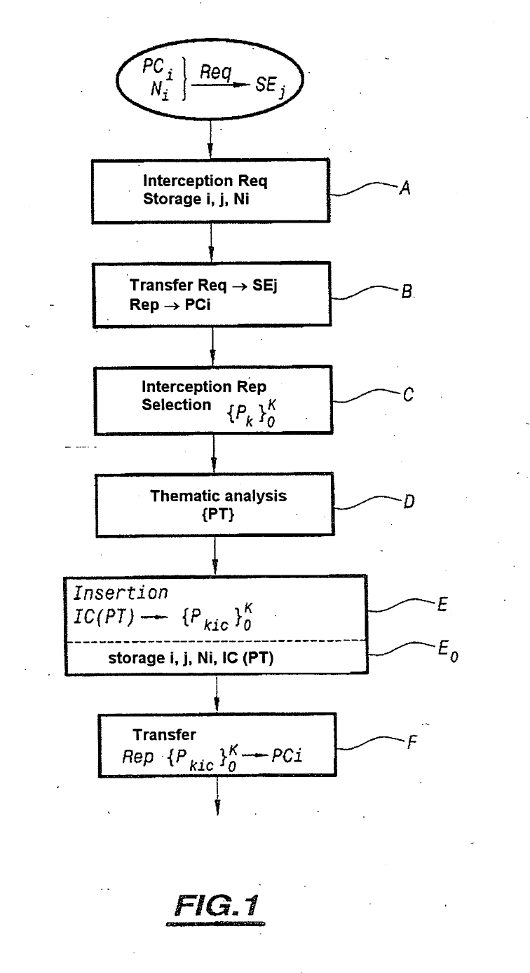

FIG. 1 represents, by way of illustration, a flow chart of the essential steps allowing the implementation of the method of inserting thematic filtering information pertaining to objects accessible on an INTERNET site, which can be consulted on the WEB, in accordance with the subject of the present invention.

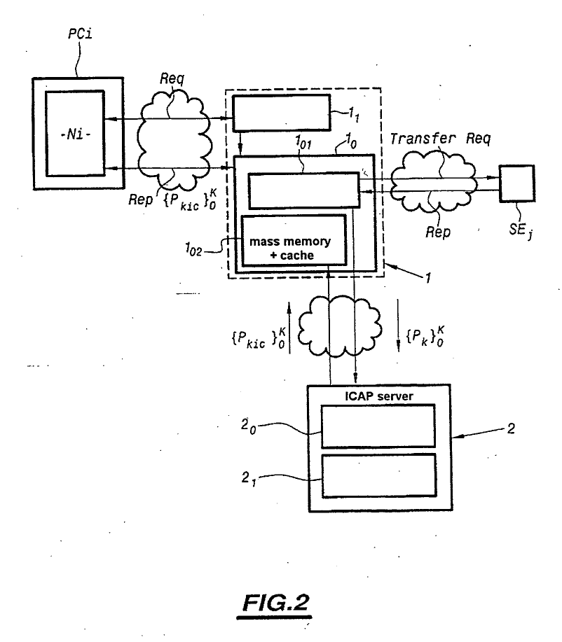

FIG. 2 represents, by way of illustration, a functional diagram of the implementation of a system for inserting thematic filtering information pertaining to objects accessible on an INTERNET site, in accordance with the subject of the present invention.

A more detailed description of the method of inserting thematic filtering information pertaining to objects accessible on an INTERNET site and of a corresponding system will now be given in conjunction with FIG. 1 and FIG. 2.

With reference to FIG. 1, it is indicated that the method for inserting thematic filtering information pertaining to objects accessible on an INTERNET site, which can be consulted on the WEB, which is the subject of the present invention, relates to objects accessible on an INTERNET site, that can be consulted on the WEB, hosted by a WEB server SEⱼ with the help of a client facility PCᵢ furnished with a browser Ni. The client facility PCᵢ and the WEB server SEⱼ are connected to the IP network. The concept of accessible object has been defined previously in the description.

The method, which is the subject of the present invention, is implemented in the usual situation according to which every request for HTTP access to the WEB server SEⱼ is sent from the client facility PCᵢ by way of this browser.

The method which is the subject of the invention then consists at the level of the core of the network, within a step A, in intercepting the access request Req so as to store at least one transaction parameter for this request for HTTP access to the WEB server SEⱼ.

The expression transaction parameter for the aforesaid request is meant to indicate that one is dealing essentially with corresponding addresses of the client facility PCᵢ, of the WEB server SEⱼ and of a reference of the type of browser used on this client facility reference Nᵢ. The corresponding addresses are symbolized by the indices i and j.

The method which is the subject of the invention then consists at a step B in transferring the request for access to the WEB server SEⱼ and on response from the aforesaid server to this access request, this response comprising at least one object accessible on this site, in performing a step C consisting in intercepting the response Rep of the WEB server SEⱼ to the request received, in verifying whether this object carries information utilizable for the thematic analysis and in selecting at least one information-carrying object from at least one object accessible on the corresponding site.

In step C in FIG. 1, the selection operation consists in selecting a plurality of objects such as for example HTML pages denoted:

{Pk}₀^{K} this set of HTML pages designating the home page of the site for example for k=0 and every corresponding successive page. The selection operation consists in picking an object only if it is utilizable subsequently by the thematic analysis system as a function of its properties, whether it be a text file, or an image in a known format for example.

Each object such as an HTML page comprises in particular a character string, a text file, an image or other file, if appropriate an INTERNET address connected by a link to the site accessed by way of the request Req.

It is understood, in particular, that the aforesaid selection operation makes it possible to perform a selection from one or more corresponding objects, of character strings and/or images from one or more objects or HTML pages.

Step C is then followed by a step D consisting in performing a thematic analysis of this or of these objects accessible on this site so as to produce a set of thematic analysis parameters, PT.

The aforesaid thematic parameters are of course characteristic of the object, of the INTERNET site visited and/or, as the case may be, of any auxiliary site whose access address is included in an HTML page accessed and directly accessible by the web surfer using the client facility PCᵢ and the browser Nᵢ associated with the latter.

Step D is then followed by a step E consisting in inserting, with the help of the aforesaid thematic analysis parameters, a plurality of categorization information pertaining to the information item broadcast by the WEB server accessed SEⱼ. The categorization information is coded in the HTTP header and possibly in the HTML page if the object is of this type, that is to say in the home page or the set of objects or HTML pages accessible.

In step E of FIG. 1, the obtaining of the categorization information and the inserting of the latter into the HTTP header and/or itself, if the objects are of type, into the set of constituent accessible HTML pages of the object is denoted:
IC(PT)→{P_{kic}}₀^{K}

In the aforementioned symbolic relation, it is indicated that IC (PT) designates the obtaining of the categorization information coded with the help of the thematic analysis parameters PT and Pkic designates any object or HTML page of rank 0 to K into which the categorization information IC has been introduced.

Step E can then be followed by a step F consisting in transferring the response Rep from the WEB server SEⱼ, the response to the request for HTTP access to this WEB server, this response of course including a header and/or a document body containing the categorization information to the client facility instead of just the information contained in the initial response.

This operation is symbolized in step F by the relation:
Rep {P_{kic}}₀^{K}→PCᵢ.

It is thus understood that, at the level of the aforesaid client facility PCᵢ, it is possible for any authorized person to effect a control of access to the information contained in the object or objects accessible on the site with the help of appropriate programming and of the categorization information IC contained in the headers of the objects or of HTML document enhanced.

In particular, the aforesaid modus operandi appears to be particularly flexible since the operation to be performed by the person responsible for the client facility can thus by means solely of the browser Nᵢ programme, in a very detailed and selective manner, accessibility to the objects considered.

More specifically, it is indicated that the thematic analysis operation represented in step D can be executed with the help of the URL.

Furthermore, according to a variant implementation of the method which is the subject of the invention, it is indicated that the thematic analysis can also be executed with the help of the content of each object and through a systematic analysis of the object considered, whether this object comprises a string of characters or text, a still image or, as the case may be, another INTERNET address of an INTERNET site which is a satellite to the accessed site. In the latter case, it is possible to access the satellite site and to perform the implementation of a method similar to that represented in FIG. 1 for any accessible information-carrying computer object such as aforementioned texts or still images contained in the aforesaid satellite WEB site.

The previous operations may of course be implemented with the help of any software element providing for the execution of the aforesaid functions.

The operations of steps A, B, C and in particular D, E, F, may require relatively significant operations and calculation times. Such is the case in particular when a given WEB site exhibits a plurality of satellite sites for which access control also turns out to be necessary.

In order to reduce the aforesaid calculation times, step F consisting in transferring the response of the accessed WEB server, SEⱼ, to the request for HTTP access to this server with a header and/or a body of documents containing the categorization information to the client facility, may advantageously be preceded by a step of storing the transaction parameters pertaining to the request for HTTP access to this WEB server and, of course, the categorization information for reuse of the latter subsequently.

Such a modus operandi is represented in an illustrative manner in FIG. 1 by the execution of a substep E₀ of step E consisting, for example, in storing not only the addresses i, j of the client facility and reference of the browser Nᵢ that are used by the latter, address j of the server accessed but also categorization information IC (PT) for the server of address j considered and for the client facility and the browser of index and/or address i considered. This operation is carried out in substep Eo of step E represented in FIG. 1.

It is appreciated, in particular, that the storing of this information thus makes it possible, upon a new access by the same client facility PCᵢ to the same WEB server SEⱼ, to substantially eliminate step D of thematic analysis of the objects broadcast by the aforesaid server.

Under these conditions, the response Rep delivered by the WEB server SEⱼ for any new access from the same client facility PCᵢ is then subjected, after interception, to the direct insertion of the categorization information IC (PT) of step E. This of course makes it possible to save calculation time and process time.

A more detailed description of a system for inserting thematic filtering information pertaining to objects accessible on an INTERNET site in accordance with the subject of the present invention will now be given in conjunction with FIG. 2.

In a general manner, it is indicated that the system which is the subject of the invention is intended to be installed at the level of the core of an IP type network for example, the core of this network in fact connecting any client facility PCᵢ furnished with a browser Nᵢ to any WEB server SEⱼ hosting one or more INTERNET sites, for example.

As represented in FIG. 2, it is indicated that the system which is the subject of the invention comprises a module 1 for interception, control and redirection of any request Req for HTTP access to this WEB server SEⱼ sent from the client facility PCᵢ by way of the browser Ni and also of the response Rep of the WEB server SEⱼ to the aforesaid request Req.

With reference to the method which is the subject of the present invention and which is described in conjunction with FIG. 1, it is indicated that the interception, control and redirection module 1 makes it possible to select the objects carrying information utilizable by the analysis module.

Furthermore, as represented in FIG. 2, the system which is the subject of the invention comprises a thematic analysis module 2 interconnected with the previously mentioned interception, control and redirection module 1. The thematic analysis module 2 receives at least one information-carrying computer object.

The object enhanced by means of thematic analysis parameters is delivered to the interception, control and redirection module 1 by the thematic analysis module 2. The aforesaid objects are enhanced by means of thematic analysis parameters characteristic of the INTERNET site and of themselves, that is to say, ultimately, of the categorization information IC (PT) previously described in relation to the method which is the subject of the invention.

The interception, control and redirection module 1 allows the forwarding of the response of the WEB server SEⱼ comprising the categorization information arising from the thematic analysis parameters to the client facility PCᵢ.

Control of access to the information contained in the HTML document accessible on the site is then performed at the level of the client facility as indicated previously in relation to the method which is the subject of the invention.

A more specific mode of implementation will now be described by way of example in relation to the system which is the subject of the invention.

As represented in FIG. 2, the module 1 for interception, control and redirection of any request for HTTP access to the WEB server SEⱼ and of the response Rep of the aforesaid server to this request Req can comprise at least one “proxy-cache” device-1₀ receiving the access request and forwarding this access request Req to the WEB server SEⱼ. The “proxy-cache” device also receives the response of the WEB server Rep to the access request.

Recall that the concept of “proxy-cache” device covers that of proxy software or of hardware allowing the execution of such software and generally comprising a storage unit.

In particular, the “proxy-cache” device-1₀ comprises, as is represented in FIG. 2, a module 1₀₁ for selecting at least one object accessible on the INTERNET site and contained in the response Rep forwarded by the WEB server SEⱼ.

In a simplified mode of implementation, with reference to FIG. 2, it is indicated that the “proxy-cache” device can be mounted directly as a firewall-type break thus making it possible to ensure the interception both of the request Req sent by the client facility PCᵢ and of the response Rep sent by the WEB server SEⱼ.

Conversely, in a more elaborate mode of implementation, in particular when the system which is the subject of the invention is installed so as to provide for the management of a large number of requests Req, the interception, control and redirection module 1 can advantageously furthermore comprise a router 1₁ operating as an intermediate buffer circuit for intercepting and redirecting the transaction formed by the request for access to the WEB server to the “proxy-cache” device.

This second mode of implementation of the interception, control and redirection module 1 makes it possible to process a bigger throughput of requests, in particular by lightening the processing load of the “proxy-cache” device as regards the interception and redirection functions.

Finally, as represented in FIG. 2 and independently of the implementation or of the absence of implementation of a router 1₁, the module 1 for interception, control and redirection of any request for HTTP access to the WEB server SEⱼ advantageously comprises a module 1₀₂ for storing any enhanced object, that is to say the set {P_{kic}}₀^{K}, by means of the thematic analysis parameters characteristic of the INTERNET site visited.

In a nonlimiting specific exemplary implementation, it is indicated that the storage module 1₀₂ can advantageously consist of a mass memory such as a high-capacity hard disk accessible through a buffer memory of fast RAM memory type for example.

Finally, for the implementation of the thematic analysis module 2, it is indicated, with reference to FIG. 2, that the aforesaid module may advantageously be implemented in an ICAP server, this type of server being a standardized server for INTERNET CONTENT ADAPTATION PROTOCOL server. This type of server is capable together with suitable software of calculating (module 2ₒ) the theme associated with an object contained in any object or HTML page as a function of the header page and of the body of the document through textual analysis and/or image analysis for example.

Furthermore, this type of server in conjunction with a search engine advantageously makes it possible to exploit any categorization tag already set by certain of the WEB servers hosting particular INTERNET sites.

Finally, as is represented furthermore in FIG. 2, the thematic analysis module 2 also comprises a module 2₁ for inserting the thematic analysis parameters and/or categorization information IC (PT) into the object or objects such as accessible HTML pages.

By way of nonlimiting example, it is indicated-that the module 2₁ for inserting tags allows insertion of tags standardized as a function of enhancement rules bound to the PICS/RSACi standard of the thematic nature of the computer object considered.

Recall that the initials RSACI, for “Recreational Software Advisory Council” for the Internet designates a system for classifying Web pages with the help of tags describing the latter's content.

As far as the installation of the system which is the subject of the invention is concerned, it is indicated that this system may be installed either at the level and under the responsibility of any INTERNET network access provider, or, as the case may be, at the level and under the responsibility of the operator of this network.

In both cases, the physical installation of the interception, control and redirection modules 1 and thematic analysis modules 2 may be carried out by way of a local area network LAN or, on the contrary, by way of a wide area network WAN.

It is appreciated in particular that when the system which is the subject of the invention is installed at the level and under the responsibility of a plurality of access providers, it is conceivable to use a single thematic analysis module in ICAP server form, connection in this situation then being carried out by way of a wide area network WAN.

The method and the system which are the subject of the present invention appear to be particularly advantageous in so far as they allow any user of a client facility and/or any person ultimately having responsibility and authority over the use of this client facility to introduce very simple control of access to the information broadcast by any WEB server hosting a specific INTERNET site, the only operations of configuration at the level of the client facility corresponding to operations of selecting keywords, for example, from a menu of the browser, of which the aforesaid person is presumed to have good mastery.

1. A method of inserting thematic filtering information pertaining to objects accessible on an INTERNET site hosted by a WEB server with the help of a browser of a client facility connected to the IP network, characterized in that the latter consists at least, for every request for HTTP access to this WEB server sent from the client facility by way of this browser, at the level of the core of this network in:
a) intercepting at the level of the core of this network the access request so as to store at least one transaction parameter of this request for HTTP access to this WEB server;
b) transferring this request for access to the WEB server; and on response from this WEB server to this access request comprising at least one object accessible on this site;
c) intercepting this response from this WEB server to this access request and selecting at least one object accessible on this site;
d) performing a thematic analysis of this at least one object, so as to produce a set of thematic analysis parameters which is characteristic of this INTERNET site;
e) inserting with the help of these thematic analysis parameters at least one coded categorization information item into the HTTP header of the response of the WEB server and/or into the object itself;
f) transferring the response of the WEB server to the request for HTTP access to this WEB server with a header and/or a document body containing the categorization information to the client facility, thereby making it possible, at the level of the said client facility, to effect a control of access to the information contained in the object or objects accessible on this site.

2. The method according to claim 1, wherein the said at least one transaction parameter of the request for HTTP access to this WEB server contains, in addition to the INTERNET addresses of the client facility and of this WEB server, a parameter identifying the type of browser of the client facility issuing the access request.

3. The method according to claim 1, wherein the said thematic analysis is executed with the help of the URL.

4. The method according to claim 1, wherein the said thematic analysis is executed with the help of the content of each object.

5. The method according to claim 1, wherein the step consisting in transferring the response of the WEB server to the request for HTTP access to this WEB server with a header and/or a document body containing the categorization information to the client facility is preceded by a step of storing the transaction parameters of the request for HTTP access to this WEB server and the categorization information for subsequent reuse.

6. A system for inserting thematic filtering information pertaining to objects accessible on an INTERNET site hosted by a WEB server with the help of a browser of a client facility connected to the IP network, said system including at least, at the level of the core of this network:
means of interception, of control and of redirection of every http request for access to this WEB server sent with the help of this client facility by way of this browser and of the response of this WEB server to this request, the said means of interception, of control and of redirection making it possible at least to select from the said response of this WEB server at least one object accessible on this INTERNET site;
thematic analysis means interconnected with the said means of interception, of control and of redirection and receiving the said at least one object and delivering to the said means of interception of control and of redirection this object so as to enhance it by means of thematic analysis parameters characteristic of this INTERNET site, the said means of interception, of control and of redirection allowing the transmission of the response of this WEB server comprising categorization information arising from the said thematic analysis parameters to the said client facility, thereby making it possible to effect, at the level of this client facility, a control of access to the information contained in this object accessible on this site.

7. The system according to claim 6, wherein the said means of interception, of control and of redirection of every request for HTTP access to this WEB server and of the response of this WEB server to this request comprise at least one “proxy-cache”, receiving the said access request and forwarding this request for access to this WEB server, the said “proxy-cache” receiving the response from this WEB server to this access request and furthermore comprising a means of selecting at least one object accessible on this INTERNET site.

8. The system according to claim 7, wherein the said means of interception, of control and of redirection furthermore comprise a router operating as an intermediate buffer circuit for intercepting and redirecting the transaction formed by the request for access to the WEB server to the said “proxy-cache”.

9. The system according to claim 6, wherein the said means of interception, of control and of redirection of every request for HTTP access to this WEB server furthermore comprise a means of storing this object enhanced by means of thematic analysis parameters characteristic of this INTERNET site.

10. The system according to claim 6, wherein the said means of thematic analysis are implemented in an ICAP server, comprising at least one module for thematic analysis of this object.

11. The system according to claim 10, wherein the said means of thematic analysis furthermore comprise a module for inserting the thematic analysis parameters and/or categorization information into this object.

12. A module for interception, control and redirection of an http request for access to objects accessible on an INTERNET site hosted by a WEB server, this request being sent with the help of a browser of a client facility connected to the IP network, and of the response of this WEB server to the said request, the said module for interception, control and redirection making it possible at least to select from the said response of this WEB server at least one object accessible on this INTERNET site.

13. The interception module according to claim 12, said interception module including at least one “proxy-cache” receiving the said access request and forwarding this request for access to this WEB server, the said “proxy-cache” receiving the response from this WEB server to this access request and furthermore comprising a means of selecting at least one object accessible on this INTERNET site.

14. The interception module according to claim 12 said interception module furthermore including a means of storing the said object accessible on this INTERNET site, the said object being an object enhanced by means of thematic-analysis parameters characteristic of this INTERNET site.

15. A thematic analysis module receiving an information-carrying computer object, this object being accessible on an INTERNET site hosted by a WEB server, and intended for a client facility connected to the IP network upon request sent with the help of a browser of this client facility, the said thematic analysis module delivering the said accessible object and thematic analysis parameters characteristic of this INTERNET site.

16. The thematic analysis module according to claim 15, said thematic analysis module being implemented in an ICAP server, comprising at least one software module for thematic analysis of this object.

17. The thematic analysis module according to claim 16, said thematic analysis module furthermore including a module for inserting the said thematic analysis parameters and/or categorization information into the said object.
